(19) United States
(12) Patent Application Publication
(10) Pub. No.: US 2026/0278417 A1
(43) Pub. Date: Sep. 17, 2026

(54) AI SYSTEM FOR ENHANCING MORAL AND NON-MORAL DECISION-MAKING

(71) Applicant: Mark D. Robinson, Singapore (SG)

(72) Inventor: Mark D. Robinson, Singapore (SG)

(21) Appl. No.: 19/566,210

(22) Filed: Mar. 13, 2026

Related U.S. Application Data
(60) Provisional application No. 63/771,218, filed on Mar. 13, 2025.

(51) Int. Cl. G06N 5/04; G06F 16/28

(52) U.S. Cl. CPC G06N 5/04; G06F 16/288

(57) ABSTRACT

A computer system for aiding in decision-making in a situation involving one or more users. The system includes an Artificial Intelligence (AI) model trained by existing decision-making data and generalized data made up of relationships between properties and quality of decision-making, configured to accept the inputs from the input devices and responses to one or more written or verbal prompts and generate decision-enhancing suggestions as output.

### CROSS-REFERENCE TO RELATED APPLICATIONS

This application is a non-provisional and claims benefit of U.S. Provisional Application No. 63/771,218 filed Mar. 13, 2025, the specification of which is incorporated herein in their entirety by reference.

### FIELD OF THE INVENTION

The present invention is directed to an AI system for enhancing moral and non-moral thinking and decision making.

### BACKGROUND OF THE INVENTION

At present, ethical decision-making is done by hand because ethics heretofore is thought of as solely a humanistic domain. University and hospital ethics committees still make their decisions using only committee conversations (and often not even with that) and perhaps writing down only the facts of the case under consideration and the verdict. As theorized by impairment theory, the number of impediments that degrade an unassisted human are innumerable, ranging from the use of incorrect facts to unintentionally biased decision-making. Per impairment theory, ethics is impossible without a computer because these many fallacies, informatic deficits, emotional and psychological factors, etc., simultaneously impair unassisted decision agents and similarly blind individuals to the frequently non-moral nature of decisions often assumed to be moral. Lastly, even the simple collection of relevant facts and organization of all of the information for ethical decisions are enhanced by the use of software over the handwritten process that is used at present, however, using software to help resolve the challenges that degrade all decisions enables a rare opportunity. This invention uses AI to enhance all decisions via inversion—seeking to overcome the ever-growing number of roadblocks to high-quality, thoroughly reasoned, informationally supported, and low-bias decisions and thinking. This invention is for an AI-led thinking & decision partner.

There are other industries outside of ethics in which software is used to guide decisions, namely, recidivism software forjudges and Grammarly®'s software for writing. Taking the example of recidivism software, which judges use to assess the statistical likelihood that an accused person may recommit a given crime, the only data used for such systems involves analysis of existing data and research and statistics about crime, criminality, and the likelihood of re-offense. However, nearly all problems with decisions result from innumerable human errors; missing information, procedural misunderstanding, biases, and more. Therefore, for instance, one judge's particular tendency to overlook specific facts repeatedly across cases or an unknown bias in that judge's decisions are missed by such software, missing the vast majority of the causes of poor decisions judicially. Similarly, grammar programs simply apply grammar rules to suggest improvements in grammar, spelling, and sentence structure but do not track personalized deficiencies that likely give rise to these errors or assess the truth quality of the claims of the sentences the user is creating, for example. The only way to ensure the highest quality decisions across all areas and situations is to provide support in all areas of deficiency, which requires technology that assesses the decision maker itself or herself as well as technology that can even determine the factuality of users' claims.

According to a brand-new theory of human morality, impairment theory, myriad factors degrade the components required for optimal decision-making generally and for moral decisions in particular (including moral and non-moral actions by non-human agents). According to this theory, the quality and number of impediments are so significant that software is essential for ethics to be possible. Thus, there exists a present need for software implementation that allows moral and non-moral decisions to be improved through interventions designed to deal with these degrading factors.

### BRIEF SUMMARY OF THE INVENTION

It is an objective of the present invention to provide systems that allow for enhancing moral and non-moral decisions by addressing known and unknown risks that impair agents during decision making, as specified in the independent claims. Because non-moral and moral decisions are decision-types of a vastly different kind, it is necessary to clearly assert the invention's design, which aims to enhance both decision types. The technology even includes AI that goes out and seeks new data about what inhibits and affects decision-making. Embodiments of the invention are given in the dependent claims. Embodiments of the present invention can be freely combined with each other if they are not mutually exclusive.

The techniques described herein relate to systems, computer-implemented methods, and non-transitory computer for: a) receiving a plurality of inputs corresponding to one or more users from a plurality of input devices communicatively coupled to the processor, each input of the plurality of inputs including measurements of one or more physiological parameters, measurements of one or more environmental parameters, and one or more user inputs including one or more user-proposed actions; b) inputting the plurality of inputs into a decision Artificial Intelligence (AI) model trained by existing decision-making data including relationships between properties and quality of decision-making, configured to accept the plurality of inputs from the plurality of input devices and identify one or more decision-making impediments in the plurality of inputs; wherein the decision AI model is further trained by past decisions made by the decision-making user and decision-enhancing suggestions thereof, such that the decision AI model provides personalized aid to the decision-making user; c) inputting the one or more decision-making impediments into a database AI model communicatively coupled to the decision AI model, trained by a database of known impediments to optimal decision making and thinking, configured to accept the one or more decision-making impediments from the decision AI model and generate one or more decision-enhancing suggestions as output; and d) returning the one or more decision-enhancing suggestions from the database AI model.

Most crucially, the system may comprise one or more processors designed to assess the decision-making agent's responses and actions against databases of risks, information, data, and enhancements that are known to help decision-makers, their decisions, and their thinking processes. The system may further comprise a processor coupled to the cloud server, one or more input devices, and a memory component comprised of data that track an individual across a host of decision types, environments, and historical decisions. This novel technical aspect comprises keeping and analyzing data about individual decision-makers across long periods and learning that person, thus creating uniquely personalized decision and thinking-support suggestions in the future. This technology may “learn” its users and then use that knowledge to provide customized suggestions, whether the user is a judge using recidivism software, a self-driving car using brand new research that helps it identify pedestrians walking 100 feet ahead, or a person with disabilities or cognitive diminishments who relies on the technology (which gradually learns him) to help him complete tasks at all his employers and make decisions outside of work, such as at school.

The technical challenges at hand include 1. how to integrate the assessments of all the potential impediments known to hinder decisions in all contexts and areas into a single platform, 2. how to use these assessments to enhance decision quality, 3. how to discover new impediments as new social science research reveals more information about human behavior and integrate this knowledge to refine this diagnostic and enhancement tool, 4. how to deliver interventions to users to enhance decision quality based on the results of the above assessments, 5. how to tie data from external hardware and devices into an AI platform, and 6. how to deliver these interventions and support via an integrated GUI via a native software application, browser extension, native desktop app, software add-in, online tool, mobile app, as well as an overlay tool that allows the decision-support tech to be used by users working in totally exogenous digital environments.

Thus, to use AI to help resolve problems at work in all moral and non-moral reasoning, this AI invention 1) Simultaneously assesses all of the impediments listed in the following sections, which include (but it is not limited to) psychological, cognitive, bio-genetic, and emotional assessments of decision-makers, 2), guides decision-makers through software-based prompts, questions, and other activities designed to enhance the quality of decisions using the assessments above. 3) autonomously assesses the truth quality of large amounts of data and information upon which decision-making processes crucially rely, 4) intervenes (using decisional or moral prosthetics) in each impediment found to degrade decision quality, which may be aided by AI that provides multiple attentional, calculative, cognitive, de-biasing, diagnostic, ethical, emotional, empathic, heuristic, informatic, spatiotemporal, and other suggestions to users as well as, provide relevant data, information, and research, all on demand, while also tracking the quality of the decisions across time and the outcome of said decisions.

In addition to the challenge of designing AI capable of simultaneous assessment, measurement, categorization, and intervention, the platform consequently integrates many systems and software programs into a single platform. Additionally, to help improve decisions at a system level, the system also creates data around decision-makers at a group level and enhances the tool's capacity to improve decision quality using data gathered about a significant number of decisions and decision-makers. Thus, this platform solves issues of data compatibility, integrity, transformation, diversity, assessment, and analysis; problems related to software latency and performance bottlenecks; impediments to scaling produced by significant volumes of system integrations, users, and especially data; issues related to the dependencies among heterogeneous components and systems.

Lastly, the tool works as a native software application, browser extension, native desktop app, software add-in, online tool, mobile app, as well as an overlay tool, which allows the decision-improvement tool to be used by users in other non-native digital environments whereby suggestions are provided to users to enhance their decisions across all situations and contexts. For example, the tool helps private equity executives ensure that their contracts contain the same information that it has found in other parts of the due diligence process. The tool reads the forms the user is filling out or reading, assisting the decision-maker in exogenous digital environments.

The present invention is a system designed around and designed to employ semiotically-capable algorithms within an algorithmic system. There are no AI inventions that use semiotically-capable algorithms to process all associated inputs at the same time and provide live probabilistic suggestions and do this at the same time as the live processing. Additionally, no AI does these particular, simultaneous trillion-parameter calculations of this specific set of inputs. The present invention offers a thermostat-like capacity, which can then be used for decision enhancement, providing backend, technological, algorithmic work and coordination (and does so simultaneously) that makes later-stage decision support possible.

The present invention features real-time, probabilistic augmentation of decision architecture, decision processes, and decisions, using real-time, live data about the decision-maker and external contexts. The present invention implements up to 500 internal, changing, always-dynamic variables as well as the thousands of external variables—also dynamics that are always influencing the decision at hand and thusly, the augmentation actions, suggestions, enhancements that are needed and that could only be achieved algorithmically. The present invention takes in large, heterogenous data required for decision augmentation and employs algorithmically-enabled probabilistic analysis and suggestions, employing data about the likely next actions of decision-makers, the environmental factors that are likely upcoming, based on past data, and to automate, where needed, decisions entirely.

The present invention features an AI-driven engine that helps to coordinate the mass of dynamics, internal and external variables that must be managed, measured, assessed and accommodated for the decisional support that the invention delivers to function. The system not only contains a complex backend, with a programmed decisions database, task prioritization, previous decisions data storage, organizational policies, agent decision-histories, organizational procedures databases, workflow journey determinations, workflow journey preview, but its decision enhancement systems use decision research data, decision support.

The present system amalgamates the innumerable live user data points (such as the physiology of the decision-maker, the amount of time that a decision-maker is taking at various decision steps, as well as live data feeds from the client, say, about market activity, regulatory changes, additional by-the-minute relevant, exogenous data points, where the present invention is used to help a decision-maker, live, with decision-making about an investment banking decision, and provides real-time data, monitoring of nearly innumerable decision-relevant data. In the case of live decision-making, this is crucial for the kinds of decision support that this innovation provides, and for which algorithms can provide precise predictions and probabilities-based predictions about how to augment the decision-maker in real-time contexts. Such augmentation-oriented actions include new question-decision-action pathways, based on real-time data whereby the present invention intervenes and asks questions that have, based on probabilities, provided useful assistance at this decision scenario. In some cases, the present invention may reroute that specific portion of the decision to another stakeholder who excels at that aspect of the task. and the system provides real time augmentation, guidance, assistance, or decisional takeover.

In its software-led workflow contexts, the present invention uses algorithms to—in real time—rearrange workflows based on the myriad decision-maker data points that it monitors, live, all with the aim of decision enhancement. This means that on days where the decision-maker is especially fatigued from a complex decision, the present invention recommends a break, another activity, or rearranges the workflow to locate another difficult decision to another day of the week. Additionally, the External Information Database provides the present invention with other probabilistic data that affects the workflow journey determination tools. For example, where a company reorganization is occurring, it may rearrange employee workflows to accommodate for that reorganization in ways that support stakeholders. The ability to mediate all of this data live from the decision-maker herself and the organization and all relevant exogenous data—all at the same time—is only possible via algorithms.

Additionally, because a large part of the present invention's value comes from real-time determinations of decisional risk, the live data recording, analysis, predictive assessments, and augmentations require algorithms. Where the present invention creates a quick cognitive-assessment of an aging surgeon an hour before surgery, The present invention's real-time assessment (using an assessment probabilistically likely to accurately identify cognitive states that are highly associated with errors), combined with other kinds of assessments combined with calculations about the complexity of the upcoming surgery—may compel the present invention to propose that the surgery be postponed or redirected to other clinicians, based on-the-spot assessments that themselves are caused by live data indicators. The decisions-risk database also gets updated by this and any new data point about decisions that possess similar contextual and situational characteristics.

Additionally, the present invention implements algorithms to transform the billions of decisions it tracks into new data, analysis, intelligence, and augmentation actions to continually enhance decisions. Thus, the AI-Enhanced Final Decision which the user-facing decision-enhancement system, is not possible without the amalgamating, coordinating, assessing, learning, of a system that mediates many different kinds of data types. Additionally, since so much of the data that the present invention incorporates to enhance decisions may involve probabilistic analysis, only algorithms could perform the complex on-the-spot probabilistic calculations needed for fast, live decision augmentation to enhance decisions. Probabilistic inference drives the augmentation-related actions to execute, using live and stored data about the decision, decision-maker, and external context data.

One of the unique and inventive technical features of the present invention is the implementation of a plurality of physiological and non-physiological measurements as input and training data for an AI system. Smart devices, ranging from smart watches to devices that measure one's mood or even oxygen or light levels in a given room, etc., are data that can be used to determine the risks and potential outcomes of decisions in that context. For example, new research about how people with autism walk means self-driving cars' CCTV data and AI agent's interactions with neurodivergent persons can be transformed into data fed back into its own software to enhance its decision-making involving people with disabilities. Smart cars, robots, software, and non-human agents are agent types whose decisions are improved by the present invention. Without wishing to limit the invention to any theory or mechanism, it is believed that the technical feature of the present invention advantageously provides something new. By using smart devices and the internet of things (IoT) as tools of distributed cognition (sometimes called distributed computing) this AI invention uses data and hardware that is outside itself for thinking and “reasoning.” This unique and inventive technical feature combined with the technical elements specified in the preceding paragraphs may help agents achieve high-quality ethical and objective decision-making. None of the presently known prior references or works have the unique inventive technical feature of the present invention. Separate from its technical novelty, this AI technology could enable non-moral decisions at a quality level never before seen in human history and may allow for truly ethical decisions to be made for the first time in history.

In some embodiments, the AI system of the present invention improves upon existing AI and technical solutions in the field. This is because the present invention enables the use of different kinds of training data. Specifically, the present invention features an AI model that is able to accept training data comprising the most modern guidelines applicable to various fields and relationships between decisions and “success” in that field, which may vary depending on the given field, environment, social climate, etc. The system also invents a new AI model that ties physiological parameters (e.g. facial expressions, cortisol levels, heart rate, etc.), written and verbal responses (say, to competence-assessment questions) to assessments of decision-making and thinking quality. This trains the model to accept users' writings, and responses, as well as physiological and non-physiological parameters as input and produce an assessment of decision-making quality as well as proposed decision-improvement suggestions as one among many kinds of output. Thus, the AI system of the present invention enables the use of different kinds of training data, enables it to turn exogenous data into data that can be used to enhance decisions and thinking, and uses existing technologies in new ways. For example, medical device companies have tools that can detect Alzheimer's risk by assessing a user's voice. The present invention may use said voice prompts to evaluate surgeons at risk for Alzheimer's, reducing known risks of cognitive decline for surgical outcomes—helping patients, surgeons, hospitals, and medical insurers who could then eliminate that entire risk area.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWINGS

The features and advantages of the present invention will become apparent from a consideration of the following detailed description presented in connection with the accompanying drawings in which:

FIG. 1A shows a schematic diagram of a system for aiding in decision-making in a situation involving one or more users.

FIG. 1B shows a flow chart of a method for aiding in decision-making in a situation involving one or more users.

FIG. 1C shows a schematic diagram of a non-transitory computer medium for aiding in decision-making in a situation involving one or more users.

FIG. 2A shows a first flow chart of the data flow of the decision-making system of the present invention.

FIG. 2B shows a second flow chart of the data flow of the decision-making system of the present invention.

### DETAILED DESCRIPTION OF THE INVENTION

Following is a list of elements corresponding to a particular element referred to herein:
system 100
input devices 110
cloud server 120
semiotic database 123
data pre-processing module 124
decision AI model 125
database AI model 126
processor 130
memory component 140

The term “context” is defined herein as a particular situation, determined by the present invention based on the identification of a certain proportion of terms in the semiotic database relating to said particular situation.

The term “tone” is defined herein as particular mood or inflection expressed by a user, determined by the present invention based on the identification of a certain proportion of terms in the semiotic database relating to said particular mood or inflection.

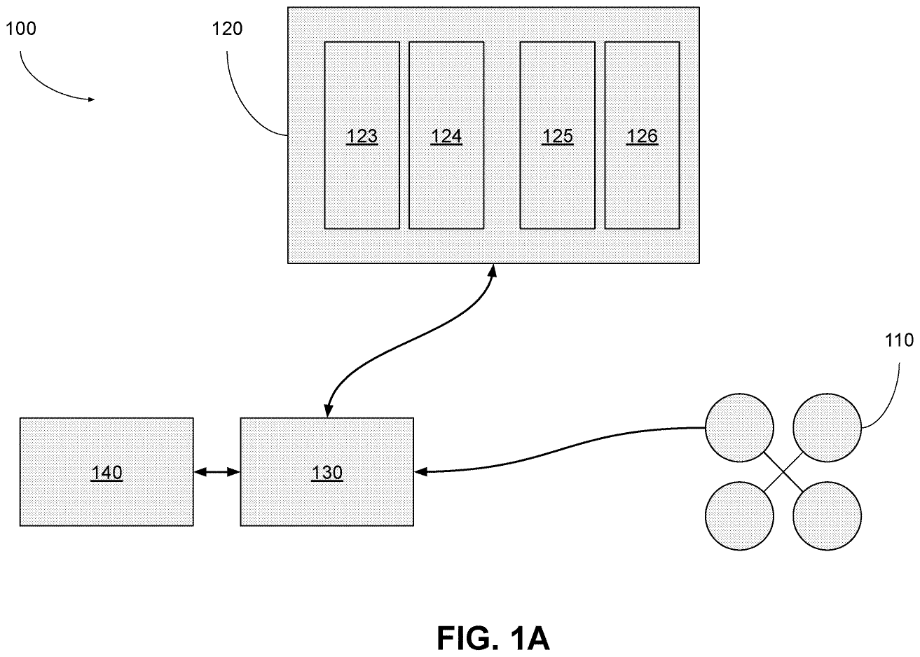

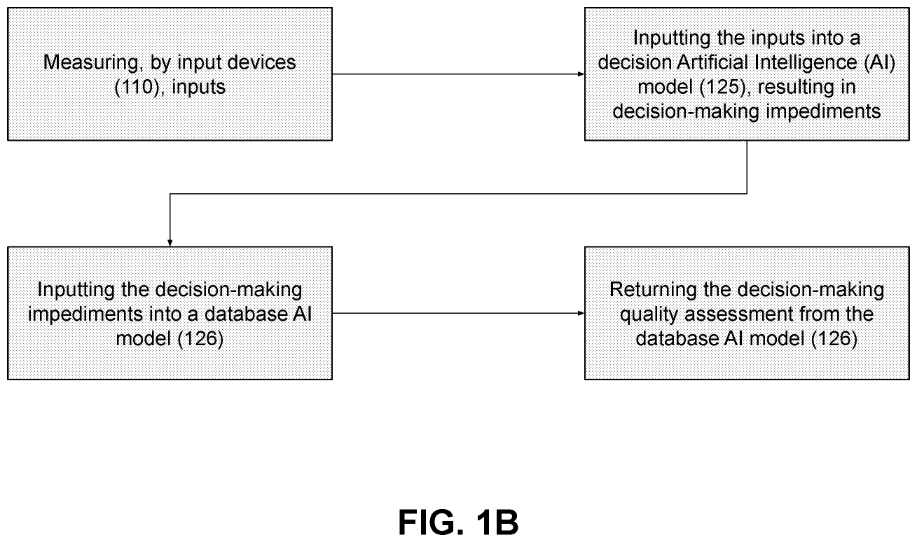

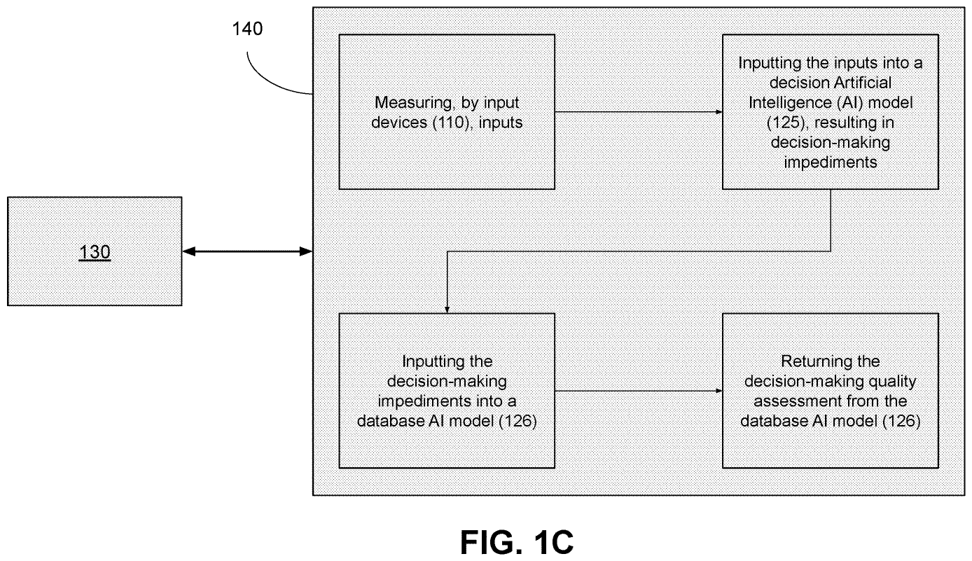

Referring now to FIG. 1A, the techniques described herein relate to a computer system (100) for aiding in decision-making in a situation involving one or more users, the system (100) including: a) a plurality of input devices (110) including one or more cameras, one or more microphones, one or more physiological sensors, and one or more text-input interface devices, each input device configured to accept a plurality of inputs from the one or more users, each input of the plurality of inputs including measurements of one or more physiological parameters, measurements of one or more environmental parameters, and one or more user inputs including one or more user-proposed actions; b) a cloud server (120) communicatively coupled to the plurality of input devices (110) including: i) a behavior-based user profile associated with a decision-making user of the one or more users; ii) a semiotic database including a plurality of terms, each term including one or more weighted emotional meanings, each weighted emotional meaning including a meaning of the term corresponding to a context and a tone, and a weight value corresponding to an emotional weight of the term given the context and the tone, and one or more relationships between the term and other terms of the semiotic database based on the context and the tone; iii) a data pre-processing module including computer-readable instructions for: A) receiving the plurality of inputs from the one or more users; B) identifying a plurality of terms in the one or more user inputs; C) deriving one or more physiological descriptive terms corresponding to the measurements of the one or more physiological parameters and one or more environmental descriptive terms corresponding to the measurements of the one or more environmental parameters, wherein the one or more physiological descriptive terms and the one or more environmental descriptive terms are incorporated into the plurality of terms; D) estimating, based on the plurality of terms and the semiotic database, an estimated context based on corresponding contexts according to relationships between the plurality of terms as the plurality of terms appear in the semiotic database; and E) estimating, based on the plurality of inputs and the semiotic database, an estimated tone of each user based on corresponding tones according to relationships between the plurality of terms as the plurality of terms appear in the semiotic database and the estimated context; iv) a decision Artificial Intelligence (AI) model (125) associated with the behavior-based user profile, trained by existing decision-making data including relationships between contexts and tones and quality of decision-making, configured to accept the plurality of inputs, the estimated context, and the estimated tone, identify one or more decision-making impediments in the plurality of inputs; wherein the decision AI model (125) is further trained by past decisions made by the decision-making user and outputs thereof, such that the decision AI model (125) provides personalized aid to the decision-making user; v) a database AI model (126) communicatively coupled to the decision AI model (125), trained by a database of known impediments to optimal decision making and thinking, configured to accept the one or more decision-making impediments from the decision AI model (125) and generate one or more decision-enhancing suggestions including one or more AI proposed actions, a decision quality assessment, sets of data and information supporting a recommended decision, a list of potential implications of the one or more user proposed actions, and a list of potential implications of the one or more AI proposed actions as output; and vi) computer-readable instructions for: A) accepting the plurality of inputs from the plurality of input devices (110); B) inputting the plurality of inputs from the plurality of input devices (110) into the data pre-processing module; C) inputting the plurality of inputs, the estimated context, and the estimated tone into the decision AI model (125); and D) inputting the one or more decision-making impediments into the database AI model (126); b) a processor (130) communicatively coupled to the cloud server (120) and the plurality of input devices (110), configured to execute computer-readable instructions; and c) a memory component (140) operatively coupled to the processor (130), including computer-readable instructions for: i) receiving the plurality of inputs from the plurality of input devices (110); ii) transmitting the plurality of inputs to the cloud server (120); iii) receiving the one or more decision-enhancing suggestions; and iv) displaying the one or more decision-enhancing suggestions to the one or more users.

Referring now to FIG. 1B, the techniques described herein relate to a computer-implemented method for aiding in decision-making in a situation involving one or more users, the method including: a) measuring, by a plurality of input devices (110), a plurality of inputs of the one or more users, each input of the plurality of inputs including measurements of one or more physiological parameters, measurements of one or more environmental parameters, and one or more user inputs including one or more user-proposed actions; b) inputting the plurality of inputs into a decision Artificial Intelligence (AI) model (125) trained by existing decision-making data including relationships between properties and quality of decision-making, configured to accept the plurality of inputs from the plurality of input devices (110) and identify one or more decision-making impediments in the plurality of inputs; wherein the decision AI model (125) is further trained by past decisions made by the decision-making user and decision-enhancing suggestions thereof, such that the decision AI model (125) provides personalized aid to a decision-making user of the one or more users; c) inputting the one or more decision-making impediments into a database AI model (126) communicatively coupled to the decision AI model (125), trained by a database of known impediments to optimal decision making and thinking, configured to accept the one or more decision-making impediments from the decision AI model (125) and generate one or more decision-enhancing suggestions as output; and d) returning the one or more decision-enhancing suggestions from the database AI model (126).

In some aspects, the techniques described herein relate to a method, wherein the plurality of input devices (110) include one or more cameras, one or more microphones, one or more physiological sensors, or a combination thereof.

In some aspects, the techniques described herein relate to a method, wherein the plurality of inputs include facial expression measurements.

In some aspects, the techniques described herein relate to a method further including inputting the facial expression measurements into a Convolutional Neural Network (CNN) configured to accept the facial expression measurements as input and generate a quantified mental state as output, wherein the quantified mental state is inputted into the decision AI model (125).

In some aspects, the techniques described herein relate to a method, wherein the plurality of inputs include speech analysis data, wherein the method further includes inputting the speech analysis data into a Long Short-Term Memory Network (LSTM) configured to accept the speech analysis data as input and generate a quantified mental state as output, wherein the quantified mental state is inputted into the decision AI model (125).

In some aspects, the techniques described herein relate to a method, wherein the plurality of inputs include heart rate, cortisol levels, or a combination thereof.

In some aspects, the techniques described herein relate to a method further including inputting descriptions of situations into a Generative Adversarial Network (GAN) configured to accept the descriptions of situations as input and generate the decision-making data as output.

In some aspects, the techniques described herein relate to a method, wherein the one or more user inputs include one or more text inputs, verbal inputs, non-verbal inputs, or a combination thereof, and one or more text responses from an interaction between the one or more users and a Natural Language Processing (NLP) model configured to accept a text input from the one or more users as input and return a text response to the text input as output, wherein the NLP model is trained by the decision-making data such that the one or more text responses include queries about a mental state of the one or more users.

In some aspects, the techniques described herein relate to a method further including identifying, by the NLP model, one or more decision-making impairments in the text input, and notifying, by the NLP model, the one or more users of the one or more decision-making impairments.

Referring now to FIG. 1C, the techniques described herein relate to a non-transitory computer medium (140) including computer-readable instructions that, when executed by a processor (130), cause the processor (130) to: a) receive a plurality of inputs corresponding to one or more users from a plurality of input devices (110) communicatively coupled to the processor (130), each input of the plurality of inputs including measurements of one or more physiological parameters, measurements of one or more environmental parameters, and one or more user inputs including one or more user-proposed actions; b) input the plurality of inputs into a decision Artificial Intelligence (AI) model (125) trained by existing decision-making data including relationships between properties and quality of decision-making, configured to accept the plurality of inputs from the plurality of input devices (110) and identify one or more decision-making impediments in the plurality of inputs; wherein the decision AI model (125) is further trained by past decisions made by the decision-making user and decision-enhancing suggestions thereof, such that the decision AI model (125) provides personalized aid to the decision-making user; c) input the one or more decision-making impediments into a database AI model (126) communicatively coupled to the decision AI model (125), trained by a database of known impediments to optimal decision making and thinking, configured to accept the one or more decision-making impediments from the decision AI model (125) and generate one or more decision-enhancing suggestions as output; and d) return the one or more decision-enhancing suggestions from the database AI model (126).

In some aspects, the techniques described herein relate to a non-transitory computer medium (140), wherein the plurality of input devices (110) include one or more cameras, one or more microphones, one or more physiological sensors, or a combination thereof.

In some aspects, the techniques described herein relate to a non-transitory computer medium (140), wherein the plurality of inputs include facial expression measurements.

In some aspects, the techniques described herein relate to a non-transitory computer medium (140) further causing the processor (130) to input the facial expression measurements into a Convolutional Neural Network (CNN) configured to accept the facial expression measurements as input and generate a quantified mental state as output, wherein the quantified mental state is inputted into the decision AI model (125).

In some aspects, the techniques described herein relate to a non-transitory computer medium (140), wherein the plurality of inputs include speech analysis data.

In some aspects, the techniques described herein relate to a non-transitory computer medium (140) further causing the processor (130) to input the speech analysis data into a Long Short-Term Memory Network (LSTM) configured to accept the speech analysis data as input and generate a quantified mental state as output, wherein the quantified mental state is inputted into the decision AI model (125).

In some aspects, the techniques described herein relate to a non-transitory computer medium (140), wherein the plurality of inputs include heart rate, cortisol levels, or a combination thereof.

In some aspects, the techniques described herein relate to a non-transitory computer medium (140) further causing the processor (130) to input descriptions of situations into a Generative Adversarial Network (GAN) configured to accept the descriptions of situations as input and generate the decision-making data as output.

In some aspects, the techniques described herein relate to a non-transitory computer medium (140), wherein the one or more user inputs include one or more text inputs, verbal inputs, non-verbal inputs, or a combination thereof, and one or more text responses from an interaction between the one or more users and a Natural Language Processing (NLP) model configured to accept a text input from the one or more users as input and return a text response to the text input as output, wherein the NLP model is trained by the decision-making data such that the one or more text responses include queries about a mental state of the one or more users.

In some aspects, the techniques described herein relate to a non-transitory computer medium (140) further causing the processor (130) to identify, by the NLP model, one or more decision-making impairments in the text input, and notify, by the NLP model, the one or more users of the one or more decision-making impairments.

The present invention features a computer system (100) for aiding in decision-making in a situation involving one or more users. The system (100) may comprise one or more input devices (110), each input device configured to accept one or more inputs from the one or more users, each input of the one or more inputs comprising measurements of one or more physiological parameters, measurements of one or more environmental parameters, one or more user inputs, or a combination thereof. The system (100) may further comprise a cloud server (120).

The cloud server (120) may comprise a behavior-based user profile associated with a decision-making user of the one or more users. The cloud server (120) may further comprise a decision Artificial Intelligence (AI) model (125) associated with the behavior-based user profile, trained by existing decision-making data comprising relationships between properties and quality of decision-making, configured to accept the one or more inputs from the one or more input devices (110) and a description of the situation, identify one or more decision-making impediments in the one or more inputs, the description of the situation, or a combination thereof, and generate one or more decision-enhancing suggestions as output. The decision AI model (125) may be further trained by past decisions made by the decision-making user and decision-enhancing suggestions thereof, such that the decision AI model (125) provides personalized aid to the decision-making user.

The cloud server (120) may further comprise a database AI model (126) communicatively coupled to the decision AI model (125), trained by a database of known impediments to optimal decision making and thinking, configured to accept the one or more decision-making impediments from the decision AI model (125) and generate one or more solutions to the one or more decision-making impediments at output. The one or more decision-enhancing suggestions may comprise the one or more solutions. The cloud server (120) may further comprise computer-readable instructions. The computer-readable instructions may comprise accepting the one or more inputs from the one or more input devices (110) and the description of the situation. The computer-readable instructions may further comprise inputting the one or more inputs from the one or more input devices (110) and the description of the situation into the decision AI model (125). The computer-readable instructions may further comprise returning the one or more decision-enhancing suggestions from the decision AI model (125).

The system (100) may further comprise a processor (130) communicatively coupled to the cloud server (120) and the one or more input devices (110), configured to execute computer-readable instructions. The system (100) may further comprise a memory component (140) operatively coupled to the processor (130), comprising computer-readable instructions. The computer-readable instructions may comprise receiving the description of the situation from the one or more users. The computer-readable instructions may further comprise receiving the one or more inputs from the one or more input devices (110). The computer-readable instructions may further comprise transmitting the one or more inputs and the description of the situation to the cloud server (120). The computer-readable instructions may further comprise receiving the one or more decision-enhancing suggestions.

In some embodiments, the one or more input devices (110) may comprise one or more cameras, one or more microphones, one or more physiological sensors, one or more user interface devices, or a combination thereof. In some embodiments, the one or more inputs may comprise facial expression measurements. In some embodiments, the cloud server (120) may further comprise a Convolutional Neural Network (CNN) configured to accept the facial expression measurements as input and generate a quantified mental state as output, wherein the quantified mental state is inputted into the decision AI model (125). In some embodiments, the one or more inputs may comprise speech analysis data. In some embodiments, the cloud server (120) may further comprise a Long Short-Term Memory Network (LSTM) configured to accept the speech analysis data as input and generate a quantified mental state as output, wherein the quantified mental state is inputted into the decision AI model (125).

In some embodiments, the one or more inputs may comprise heart rate, cortisol levels, or a combination thereof. In some embodiments, the cloud server (120) may further comprise a Recurrent Neural Network (RNN) configured to accept text data from one or more sources as input and generate the decision-making data as output. In some embodiments, the cloud server (120) may further comprise a Generative Adversarial Network (GAN) configured to accept descriptions of situations as input and generate the decision-making data as output. In some embodiments, the cloud server (120) may further comprise a Natural Language Processing (NLP) model configured to accept a text input from the one or more users as input and return a text response to the text input as output. The NLP model may be trained by the decision-making data such that the text responses comprise queries about a mental state of the one or more users. In some embodiments, the one or more user inputs may comprise one or more text inputs, verbal inputs, non-verbal inputs, or a combination thereof, and one or more text responses from an interaction between the one or more users and the NLP model. In some embodiments, the NLP model may be further configured to accept the text input from the one or more users as input, identify one or more decision-making impairments in the text input, and notify the one or more users of the one or more decision-making impairments.

In some embodiments, the one or more user inputs comprise one or more user proposed actions. The one or more decision-enhancing suggestions may comprise one or more AI proposed actions. The decision AI model (125) may be further configured to generate a plurality of additional outputs based on the one or more solutions from the database AI model (126), the one or more additional outputs comprising a decision quality assessment, sets of data and information supporting the recommended decision, a list of potential implications of the one or more user proposed actions, and a list of potential implications of the one or more AI proposed actions.

The present invention features a computer-implemented method for aiding in decision-making in a situation involving one or more users. In some embodiments, the method may comprise measuring, by one or more input devices (110), one or more inputs of the one or more users, each input of the one or more inputs comprising measurements of one or more physiological parameters, measurements of one or more environmental parameters, one or more user inputs, or a combination thereof. The method may further comprise receiving a description of the situation from the one or more users.

The method may further comprise inputting the one or more inputs and the description of the situation into a decision Artificial Intelligence (AI) model (125) trained by existing decision-making data comprising relationships between properties and quality of decision-making, configured to accept the one or more inputs from the one or more input devices (110) and a description of the situation, identify one or more decision-making impediments in the one or more inputs, the description of the situation, or a combination thereof, and generate one or more decision-enhancing suggestions as output. The decision AI model (125) may be further trained by past decisions made by the decision-making user and decision-enhancing suggestions thereof, such that the decision AI model (125) provides personalized aid to the decision-making user.

The one or more decision-enhancing suggestions may comprise one or more solutions generated by a database AI model (126) communicatively coupled to the decision AI model (125), trained by a database of known impediments to optimal decision making and thinking, configured to accept the one or more decision-making impediments from the decision AI model (125) and generate the one or more solutions to the one or more decision-making impediments at output. The method may further comprise returning the one or more decision-enhancing suggestions from the decision AI model (125).

In some embodiments, the one or more input devices (110) may comprise one or more cameras, one or more microphones, one or more physiological sensors, or a combination thereof. In some embodiments, the one or more inputs may comprise facial expression measurements. In some embodiments, the method may further comprise inputting the facial expression measurements into a Convolutional Neural Network (CNN) configured to accept the facial expression measurements as input and generate a quantified mental state as output. The quantified mental state may be inputted into the decision AI model (125). In some embodiments, the one or more inputs may comprise speech analysis data. In some embodiments, the method may further comprise inputting the speech analysis data into a Long Short-Term Memory Network (LSTM) configured to accept the speech analysis data as input and generate a quantified mental state as output. The quantified mental state may be inputted into the decision AI model (125).

In some embodiments, the one or more inputs may comprise heart rate, cortisol levels, or a combination thereof. In some embodiments, the method may further comprise inputting text data from one or more sources into a Recurrent Neural Network (RNN) configured to accept the text data as input and generate the decision-making data as output. In some embodiments, the method may further comprise inputting descriptions of situations into a Generative Adversarial Network (GAN) configured to accept the descriptions of situations as input and generate the decision-making data as output.

In some embodiments, the one or more user inputs may comprise one or more text inputs, verbal inputs, non-verbal inputs, or a combination thereof, and one or more text responses from an interaction between the one or more users and a Natural Language Processing (NLP) model configured to accept a text input from the one or more users as input and return a text response to the text input as output, wherein the NLP model is trained by the decision-making data such that the text responses comprise queries about a mental state of the one or more users. In some embodiments, the method may further comprise identifying, by the NLP model, one or more decision-making impairments in the text input, and notifying, by the NLP model, the one or more users of the one or more decision-making impairments.

In some embodiments, the one or more user inputs may comprise one or more user proposed actions. The one or more decision-enhancing suggestions may comprise one or more AI proposed actions. The decision AI model (125) may be further configured to generate a plurality of additional outputs based on the one or more solutions from the database AI model (126), the one or more additional outputs comprising a decision quality assessment, sets of data and information supporting the recommended decision, a list of potential implications of the one or more user proposed actions, and a list of potential implications of the one or more AI proposed actions.

The present invention features a non-transitory computer medium (140) comprising computer-readable instructions that, when executed by a processor (130), cause the processor (130) to receive one or more inputs of the one or more users from one or more input devices (110) communicatively coupled to the processor (130), each input of the one or more inputs comprising measurements of one or more physiological parameters, measurements of one or more environmental parameters, one or more user inputs, or a combination thereof. The computer-readable instructions may further comprise receiving a description of the situation from the one or more users.

The computer-readable instructions may further comprise inputting the one or more inputs and the description of the situation into a decision Artificial Intelligence (AI) model (125) trained by existing decision-making data comprising relationships between properties and quality of decision-making, configured to accept the one or more inputs from the one or more input devices (110) and a description of the situation, identify one or more decision-making impediments in the one or more inputs, the description of the situation, or a combination thereof, and generate one or more decision-enhancing suggestions as output. The decision AI model (125) may be further trained by past decisions made by the decision-making user and decision-enhancing suggestions thereof, such that the decision AI model (125) provides personalized aid to the decision-making user.

The one or more decision-enhancing suggestions may comprise one or more solutions generated by a database AI model (126) communicatively coupled to the decision AI model (125), trained by a database of known impediments to optimal decision making and thinking, configured to accept the one or more decision-making impediments from the decision AI model (125) and generate the one or more solutions to the one or more decision-making impediments at output. The computer-readable instructions may further comprise returning the one or more decision-enhancing suggestions from the decision AI model (125).

In some embodiments, the one or more input devices (110) may comprise one or more cameras, one or more microphones, one or more physiological sensors, or a combination thereof. In some embodiments, the one or more inputs may comprise facial expression measurements. In some embodiments, the computer-readable instructions may further cause the processor (130) to input the facial expression measurements into a Convolutional Neural Network (CNN) configured to accept the facial expression measurements as input and generate a quantified mental state as output. The quantified mental state may be inputted into the decision AI model (125). In some embodiments, the one or more inputs may comprise speech analysis data.

In some embodiments, the computer-readable instructions may further cause the processor (130) to input the speech analysis data into a Long Short-Term Memory Network (LSTM) configured to accept the speech analysis data as input and generate a quantified mental state as output, wherein the quantified mental state is inputted into the decision AI model (125). In some embodiments, the one or more inputs may comprise heart rate, cortisol levels, or a combination thereof.

In some embodiments, the computer-readable instructions may further cause the processor (130) to input text data from one or more sources into a Recurrent Neural Network (RNN) configured to accept the text data as input and generate the decision-making data as output. In some embodiments, the computer-readable instructions may further cause the processor (130) to input descriptions of situations into a Generative Adversarial Network (GAN) configured to accept the descriptions of situations as input and generate the decision-making data as output.

In some embodiments, the one or more user inputs may comprise one or more text inputs, verbal inputs, non-verbal inputs, or a combination thereof, and one or more text responses from an interaction between the one or more users and a Natural Language Processing (NLP) model configured to accept a text input from the one or more users as input and return a text response to the text input as output. The NLP model may be trained by the decision-making data such that the text responses comprise queries about a mental state of the one or more users. In some embodiments, the computer-readable instructions may further cause the processor (130) to identify, by the NLP model, one or more decision-making impairments in the text input, and notify, by the NLP model, the one or more users of the one or more decision-making impairments.

In some embodiments, the one or more user inputs may comprise one or more user proposed actions. In some embodiments, the one or more decision-enhancing suggestions may comprise one or more AI proposed actions. The decision AI model (125) may be further configured to generate a plurality of additional outputs based on the one or more solutions from the database AI model (126), the one or more additional outputs comprising a decision quality assessment, sets of data and information supporting the recommended decision, a list of potential implications of the one or more user proposed actions, and a list of potential implications of the one or more AI proposed actions.

In some embodiments, sets of data and information supporting the recommended decision may comprise one or more research articles, journals, individualized assessments from experts that the decision AI model has selected, official and unofficial sources, announcements on new upcoming guidance, or a combination thereof.

The present invention features a computer system (100) for aiding in decision-making in a situation involving one or more users. In some embodiments, the system (100) may comprise one or more input devices (110), each input device configured to accept one or more inputs comprising measurements of one or more physiological parameters, one or more environmental parameters, or a combination thereof, one or more user inputs, or a combination thereof. The one or more user inputs may comprise one or more responses provided in response to software prompts. The system (100) may further comprise a cloud server (120). The cloud server (120) may comprise an Artificial Intelligence (AI) model (125) trained by existing decision-making data comprising relationships between inputs and quality of decision-making, configured to accept the one or more inputs and responses to written prompts from the one or more input devices (110) and generate a decision-making quality assessment, sets of additional data and information supporting a decision, a list of potential implications from each proposed action, one or more AI-suggested decision-enhancing suggestions, or a combination thereof as output. The cloud server (120) may further comprise an additional AI model trained on a database of known impediments to optimal decision-making and thinking, configured to accept one or more inputs known to help resolve one or more of the impediments that hinder optimal decision-making and thinking and deliver help in those and other areas that hinder. The cloud server (120) may further comprise computer-readable instructions for accepting, by the one or more input devices (110), the one or more inputs, inputting the one or more inputs into the AI model, and returning the decision-making quality assessment, the sets of additional data and information supporting the decision, the list potential implications from each proposed action, the one or more AI-suggested decision-enhancing suggestions, or the combination thereof from the AI model (125).

The system (100) may further comprise a processor (130) communicatively coupled to the cloud server (120) and the one or more input devices (110), configured to execute computer-readable instructions. The system (100) may further comprise a memory component (140) operatively coupled to the processor (130), comprising computer-readable instructions. The computer-readable instructions may comprise receiving the one or more inputs from the one or more input devices (110), transmitting the one or more inputs to the cloud server (120), and receiving the decision-making quality assessment, the sets of additional data and information supporting the decision, the list potential implications from each proposed action, the one or more AI-suggested decision-enhancing suggestions, or the combination thereof from the AI model (125). In some embodiments, the computer-readable instructions may further comprise keeping and analyzing data about individual decision-makers across long periods and learning that person.

In some embodiments, the one or more input devices (110) may comprise one or more cameras, one or more microphones, one or more physiological sensors, or a combination thereof. In some embodiments, the one or more input devices (110) may comprise one or more external devices paired to the system (e.g., a smart watch), one or more devices integrated into the system (e.g., a sensor sold alongside the system software), or a combination thereof. In some embodiments, the one or more inputs may comprise facial expression measurements. In some embodiments, the cloud server (120) may further comprise a Convolutional Neural Network (CNN) configured to accept the facial expression measurements as input and generate a quantified mental state as output. The quantified mental state may be inputted into the AI model (125).

In some embodiments, the one or more inputs may comprise speech analysis data. In some embodiments, the cloud server (120) may further comprise a Long Short-Term Memory Network (LSTM) configured to accept the speech analysis data as input and generate a quantified mental state as output. The quantified mental state may be inputted into the AI model (125). In some embodiments, the one or more inputs may comprise heart rate, cortisol levels, or a combination thereof.

In some embodiments, the cloud server (120) may further comprise a Recurrent Neural Network (RNN) configured to accept text data from one or more sources as input and generate the decision-making data as output. In some embodiments, the cloud server (120) may further comprise a Generative Adversarial Network (GAN) configured to accept descriptions of situations as input and generate the decision-making data as output.

In some embodiments, the cloud server (120) may further comprise a Natural Language Processing (NLP) model configured to accept a text input from the one or more users as input and return a text response to the text input as output. The NLP model may be trained by the decision-making data such that the text responses comprise queries about a mental state of the one or more users. In some embodiments, the description of the situation may comprise one or more text inputs and one or more text responses from an interaction between the one or more users and the NLP model. In some embodiments, the NLP model may be further configured to accept the text input from the one or more users as input, identify one or more decision-making impairments in the text input, and notify the one or more users of the one or more decision-making impairments.

The present invention features a computer-implemented method for aiding in decision-making in a situation involving one or more users. In some embodiments, the method may comprise measuring, by one or more input devices (110), one or more inputs of the one or more users. The method may further comprise receiving a description of the situation from the one or more users. The method may further comprise inputting the one or more inputs and the description of the situation into an Artificial Intelligence (AI) model (125) trained by existing decision-making data comprising relationships between properties and quality of decision-making, configured to accept the one or more inputs from the one or more input devices (110) and a description of the situation, and generate a decision-making quality assessment as output. The method may further comprise returning the decision-making quality assessment from the AI model (125).

In some embodiments, the one or more input devices (110) comprise one or more cameras, one or more microphones, one or more physiological sensors, or a combination thereof. In some embodiments, the one or more inputs may comprise facial expression measurements. In some embodiments, the method may further comprise inputting the facial expression measurements into a Convolutional Neural Network (CNN) configured to accept the facial expression measurements as input and generate a quantified mental state as output. The quantified mental state may be inputted into the AI model (125).

In some embodiments, the one or more inputs may comprise speech analysis data. In some embodiments, the method may further comprise inputting the speech analysis data into a Long Short-Term Memory Network (LSTM) configured to accept the speech analysis data as input and generate a quantified mental state as output. The quantified mental state may be inputted into the AI model (125).

In some embodiments, the one or more inputs may comprise heart rate, cortisol levels, or a combination thereof. In some embodiments, the method may further comprise inputting text data from one or more sources into a Recurrent Neural Network (RNN) configured to accept the text data as input and generate the decision-making data as output. In some embodiments, the method may further comprise inputting descriptions of situations into a Generative Adversarial Network (GAN) configured to accept the descriptions of situations as input and generate the decision-making data as output.

In some embodiments, the description of the situation may comprise one or more text inputs and one or more text responses from an interaction between the one or more users and a Natural Language Processing (NLP) model configured to accept a text input from the one or more users as input and return a text response to the text input as output, wherein the NLP model is trained by the decision-making data such that the text responses comprise queries about a mental state of the one or more users. In some embodiments, the method may further comprise identifying, by the NLP model, one or more decision-making impairments in the text input, and notifying, by the NLP model, the one or more users of the one or more decision-making impairments.

The present invention features a non-transitory computer medium (140) comprising computer-readable instructions that, when executed by a processor (130), cause the processor (130) to receive one or more inputs of the one or more users from one or more input devices (110) communicatively coupled to the processor (130), receive a description of the situation from the one or more users, input the one or more inputs and the description of the situation into an Artificial Intelligence (AI) model (125) trained by existing decision-making data comprising relationships between properties and quality of decision-making, configured to accept the one or more inputs from the one or more input devices (110) and a description of the situation, and generate a decision-making quality assessment as output, and return the decision-making quality assessment from the AI model (125).

In some embodiments, the one or more input devices (110) may comprise one or more cameras, one or more microphones, one or more physiological sensors, or a combination thereof. In some embodiments, the one or more inputs may comprise facial expression measurements. In some embodiments, the non-transitory computer medium (140) may further cause the processor (130) to input the facial expression measurements into a Convolutional Neural Network (CNN) configured to accept the facial expression measurements as input and generate a quantified mental state as output. The quantified mental state may be inputted into the AI model (125).

In some embodiments, the one or more inputs may comprise speech analysis data. In some embodiments, the non-transitory computer medium (140) may further cause the processor (130) to input the speech analysis data into a Long Short-Term Memory Network (LSTM) configured to accept the speech analysis data as input and generate a quantified mental state as output. The quantified mental state may be inputted into the AI model (125). In some embodiments, the one or more inputs may comprise heart rate, cortisol levels, or a combination thereof.

In some embodiments, the non-transitory computer medium (140) may further cause the processor (130) to input text data from one or more sources into a Recurrent Neural Network (RNN) configured to accept the text data as input and generate the decision-making data as output. In some embodiments, the non-transitory computer medium (140) may further cause the processor (130) to input descriptions of situations into a Generative Adversarial Network (GAN) configured to accept the descriptions of situations as input and generate the decision-making data as output.

In some embodiments, the description of the situation may comprise one or more text inputs and one or more text responses from an interaction between the one or more users and a Natural Language Processing (NLP) model configured to accept a text input from the one or more users as input and return a text response to the text input as output. The NLP model may be trained by the decision-making data such that the text responses comprise queries about a mental state of the one or more users. In some embodiments, the non-transitory computer medium (140) may further cause the processor (130) to identify, by the NLP model, one or more decision-making impairments in the text input, and notify, by the NLP model, the one or more users of the one or more decision-making impairments.

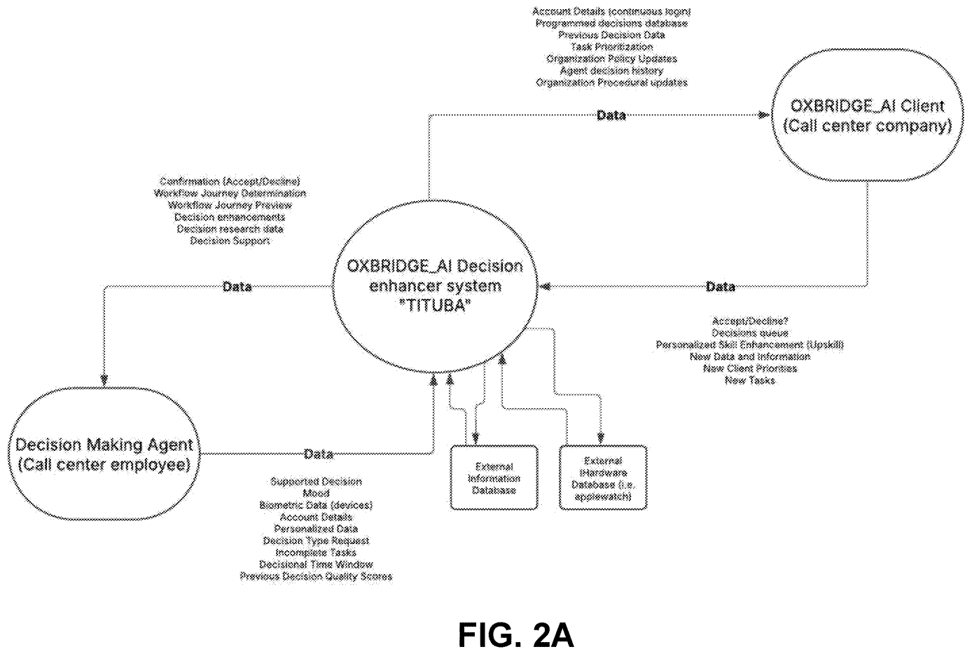

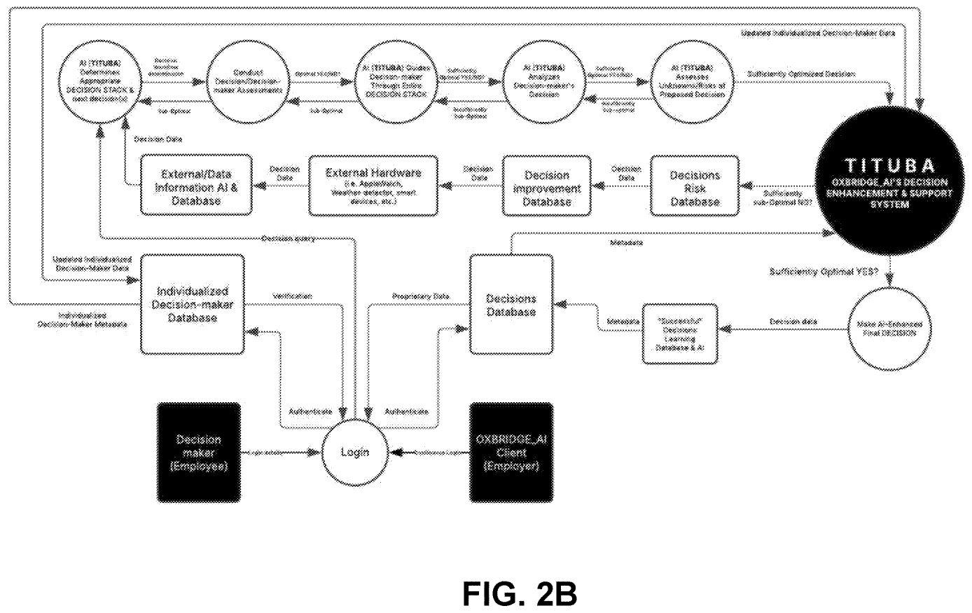

Further working examples of the flows of data and processing in the AI system of the presently claimed invention can be found in the flow charts of FIGS. 2A-2B.

Input Data: The amount and kind of data used to input the system is unusually large and diverse. At the level of decision-agents, data about one's mood, personality, biases, energy levels, cognitive styles, literacy limitations, calculative capacity, attention spans, decision capacity/fatigue, directed attention or inattention, information processing speed, psychology, memory capacity, biogenetic makeup, linguistic shaping, issue or decision comprehension, resources, previous decisions, and much more constitute system inputs.

Also, at the decision-agent level, data about aspects external to the agent, such as the situation, include vast amounts of data. For example, as applied to clinical decision-making support, data about patients, biopharmaceuticals, medical risk, outcomes, hospital protocols, specialty protocols, and much more must be integrated. Lastly, because so much of the quality of decisions involves high-quality and new relevant data, significant data are found, assessed, and integrated to resolve this key risk vector regarding decision quality. Thus, all data pertinent to any decision constitutes the data used as input into the system.

Lastly, to improve decisions at the highest level and the tool's capacity to continue to enhance decisions, the system uses a lot of data about decisions across industries, within industries, across users, and at the level of individual decision-makers over time, among other kinds of decision data. For example, as transplant surgeons' decisions about transplants are tracked, highly successful decision-makers (as, say, defined by good or clinically successful transplantation outcomes) are tracked with the goal of learning why their decisions are more successful than others using that information to enhance future decisions.

Training Data: All decision-making data are the kinds of data used to train the system. Additionally, domain-specific data (for example, around investor due diligence or clinical decision-making) involves data discovery approaches, which may involve training the system on data and information discovery processes. In addition, decisions at the individual, collective, sector, and field levels also constitute crucial data for training.

Pre-processing: The present invention features a customized AI-based data input manager dedicated to data preparation before data is put into the system. Additionally, the unusual diversity of data inputs that are used (i.e., everything from users' written responses to software prompts to the physiological data from their smartwatch—to assess that decision-maker's mood) is aided by AI for data preparation processes as there are too many values, attributes, and complexities involved in the data reduction, cleansing, normalization, and formatting. Additionally, because the system uses data about the user from various input devices, the AI-based data input manager extends to coordinate inputs from multiple data sources such as sensors, facial recognition, and voice recognition, among others.

Output and Post-processing: In short, the system's output is made usable for users through suggestions about enhancing their decisions. These suggestions include prompts to re-check information, to include more information that has been found, to review inconsistencies found in the users' own decisions, prompts to consider factors that the user had not considered, suggestions to return to the decision later when their stress levels are lower; their mood is optimal, relevant regulatory information that is on the verge of being published (for example), as well as other innumerable suggestions to enhance their decisions. In addition to assessing users/agents and their capacities, providing key data and information for decisions (and helping to authenticate said data and information), the system also intervenes via software that guides users through questions that are also designed to assess the competence of the decision-making agent and even whether the decision should be made by said decision-making agent at all. In the case of non-human agents such as autonomous military drones and autonomous vehicles, the same assessments and interventions are provided but communicated to those systems directly, effectively making those closed networks into open networks.

High-level architecture: The system of the present invention may implement Convolutional Neural Networks (CNNs) since emotional and mood assessment tools may involve analyses of the faces of human users (or even those of patients), among other uses for CNNs. The system may further comprise Recurrent Neural Networks (RNNs) since significant analyses of text and the provision of ‘recent suggestions’ are used to assess for decision opportunities, updated clinical data, fallacies, incorrect or unsubstantiated facts, and mood, among many other uses of RNNs. The system may further comprise Long Short-Term Memory Networks (LSTMs) are a subset of RNNs since they allow for speech recognition, which is crucial for assessment-related activities.

The system may further comprise Generative Adversarial Networks (GANs)—which aid in creating AI-based simulation tools that allow for full simulations of scenarios within which to test and improve decisions, decision research, etc., using real-world scenarios. The system may further comprise autoencoders such that the AI not only discovers new data, which are relevant to decisions and decision-makers but also can complete learning activities related to new information. The system may further comprise a Deep Belief Network (DBN) to enhance speech and image recognition activities, helping with assessments of users and others. The system may further comprise Graph Neural Networks (GNNs) because predictive capacities and recommendation-related capacities are crucial to the interventionist aims of the technology.

Layer structure: Each layer of each network of the system of the present invention may comprise a Presentation layer, a Business Logic layer, a Data Tier Layer, a Core Layer, an Infrastructure Layer, or a combination thereof.

Computing environment: Because the system of the present invention pulls data from various devices and systems, it relies on the Internet of Things (IoT). For example, it pulls biometric data from smartwatches, written data provided by user responses to prompts, facial recognition data from users, and external data from databases, autonomous bots, and other data sources. The user-facing computing environments include a native software application, browser extension, native desktop app, software add-in, online tool, mobile app, and an overlay tool.

Types of learning: The present invention uses supervised learning, unsupervised learning, and reinforced learning.

Functions and Parameters: In some embodiments, the AI system of the present invention may implement one or more loss functions comprising Mean squared error, Binary cross entropy, Multiclass Entropy, Categorical Cross Entropy, Sparse Categorical Cross Entropy, or a combination thereof. In some embodiments, the AI system of the present invention may implement one or more optimization algorithms comprising Genetic algorithms, Ant colony optimization, Particle swarm optimization, Stochastic gradient descent, Gradient descent, or a combination thereof. In some embodiments, the AI system of the present invention may implement one or more activation functions comprising Softmax Function, Binary step function, Linear activation function, Non-linear activation functions, Gaussian Error Linear Unit (GELU), Scaled Exponential Linear Unit (SELU), Sigmoid-logistic activation function, Tanh Function (Hyperbolic Tangent), Exponential Linear Units (ELUs) Function, Parametric ReLU Function, Leaky ReLU Function, ReLU Function, or a combination thereof.

The present invention seeks to improve decision quality over time across users and even at the level of individual decision-making agents, the training model relies on a steady stream of data about decision-makers and their decisions to help further train and update the AI model. Additionally, since the invention aims to study and learn what decision parameters, decision supports, and which decision-makers tend to produce the best decision outcomes, outcomes data (or data about “successful decisions”) becomes crucial data on which the model is continually trained and updated.

The present invention is configured to intervene in the many documented problems that debilitate moral and non-moral decision-making. Some problems include the following impediments: Emotional Incapacity, Emotional Regulation, Emotional Contagion, cognitive dissonance, ethnographic distance, Moral Distance Problem, Narcissism, Self-Deception, Ethical Fading, Overthinking (individual, episodic), Poor Reasoning Skills, Poor Reasoning Capacity, social intuitionism, intended/goal-dependent automaticity, post-conscious automaticity, pre-conscious automaticity, False Memory/Misattribution, personal religiosity, religious influence, banalization, partisanship behaviors, Mimetic Desire, Progression Bias/Overgeneralization, Prevalence-induced concept change, implicit bias, explicit bias, psychopathy/sociopathy, superstitious thinking, moral development, Mood, Stereotyping, Internal monologue, Hunger, Smells, Momentary Emotions, Energy level (physiologic), Emotional Exhaustion, Physical Exhaustion, sleep deprivation, Fatigue, Decision fatigue, Inconsistency, cognitive miser, Moral Reframing, Motivated Blindness, good-person delusion, Poor Thinking, Visual Learner, Auditory learner, failure to notice, Neurodiversity, Atypical Learning Style, Reading limitations, cognitive overload, Poor Analysis, poor situational analysis, Limited analytic capacity, poor Information Processing, Limited Calculative Skills, Limited Calculative Capacity, limited attention spans, Directed attention Fatigue, Alternating Attention, Information Processing Speed, brain fog, missing virtue, evil committed by a rational actor, irrational fear, mental illness, under influence of substances (including pharmaceuticals), individual personality, Belief Change, Belief Perseverance, Personal Development, quantitative bias, qualitative bias, Confirmation Bias, Availability Bias, Framing Effect, Primacy Effect, Recency Effect, Anchoring Effect, Attribute Substitution/Substitution Bias, Optimism Bias, Optimality Bias, Illusion of Control, Overconfidence Effect, Planning Fallacy, Affinity Bias, Hindsight Bias, Normalcy Bias, Self-serving Bias, Belief Bias, Embodied Cognition, Status Quo Bias, Conformity Bias, Dilution Effect, Moral Absolutism, Moral Blindness, Moral Shaping-Social Media, Moral Shaping-Media, Moral Shaping-Rituals, Imagery, Moral Norms, Local Moral Rules, Socialization, Parental Socialization, Dictatorial Socialization, Cultural Socialization, Power Disparities, Too-little Power, Too-much Power, Indoctrination, Momentary Manipulation, Scapegoating, too little information, too much information, improperly presented information, Tribalism, Mass-Formation Psychosis, Social Pressure, Organizational Pressure, Interpersonal Pressure, Institutional Pressure, Legal Pressure, Legislative Pressure, Technology, Ethical Antecedents, Ethical Climates, Ethical Dissonance, Responsibility Diffusion, Bystander Effects, Motivated Blindness, Poorly-Worded Question, Confusing Instructions, Cultural Relativism, Moral Relativism, Blackbox Problem, Ethics-as-a-Burden, Role Morality, Incrementalism, Loss Aversion Bias, Heuristics, Poor Memory, Persistence of Memory, Blocked Memory, Suggestibility, Lack of Empathy, Excess of Empathy, Burnout/moral injury, Individual Empathic limitation, Enslavement/Subjugated Status, Oppression/Oppressive Actions, Thematic apperception, low self-efficacy, Traumatic Experiences, Apathy, Mindset, Depersonalization, Violence (Context of), poor hearing, Long-term COVID, Gender/Sex, disparities in moral capacity (differing ethical costs), mistaken action, unintended use, limited perspective, Appeal to probability, Representativeness Bias, Argument from Fallacy, Base Rate Fallacy, Conjunction Fallacy, Worst Motive Fallacy, Masked-man Fallacy, Meteorologist Fallacy, Appeal to Intuition fallacy, Affirming a disjunct fallacy, Affirming the consequent fallacy, Denying the Antecedent fallacy, Existential fallacy, Affirmative conclusion from a negative premise (illicit negative) fallacy, Fallacy of four terms (quaternio terminorum), Illicit major fallacy, Illicit minor fallacy, Negative conclusion from affirmative premises (illicit affirmative) fallacy, Fallacy of the undistributed middle, Modal fallacy, Modal scope fallacy, Argument to moderation (false compromise, middle ground, fallacy of the mean, argumentum ad temperantiam), Continuum fallacy (fallacy of the beard, line-drawing fallacy, sorites fallacy, fallacy of the heap, bald man fallacy), Suppressed correlative fallacy, Definist fallacy, Divine fallacy (argument from incredulity), Double counting fallacy, Equivocation fallacy, Ambiguous middle term fallacy, Motte-and-bailey fallacy, Fallacy of accent, Persuasive definition fallacy, Ecological fallacy, Etymological fallacy, Fallacy of composition, Fallacy of division, Fundamental attribution error, Fallacy of quoting out of context (Contextotomy, quotation mining), False authority fallacy, False Dilemma (false dichotomy, fallacy of bifurcation, black-or-white fallacy) fallacy, false equivalence fallacy, Feedback fallacy, Historian's fallacy, Historical fallacy, Baconian Fallacy, Homunculus Fallacy, If-by-whiskey fallacy, incomplete comparison fallacy, inconsistent comparison fallacy, Intentionality fallacy, Lump of labor fallacy, Kettle logic fallacy, Ludic fallacym fallacy, McNamara fallacy (quantitative fallacy), Mind projection fallacy, Moralistic fallacy, moving the goalposts (raising the bar) fallacy, Nirvana fallacy (perfect solution fallacy), Proof by assertion fallacy, Prosecutor's Fallacy, Proving too much fallacy, Psychologist's fallacy, Referential fallacy, Reification (concretism, hypostatization, or the fallacy of misplaced concreteness) fallacy, Retrospective determinism fallacy, Slippery slope (thin edge of the wedge, camel's nose) fallacy, special pleading fallacy, Begging the question (petitio principii) fallacy, Circular reasoning (circulus in demonstrando) fallacy, Fallacy of many questions (complex question, fallacy of presuppositions, loaded question, plurium interrogationum), Faulty generalization fallacy, Mortality Salience (MS) Hypothesis, No true Scotsman/appeal to purity fallacy, Cherry picking (suppressed evidence, incomplete evidence), Survivorship bias, False analogy, Hasty generalization (fallacy of insufficient statistics, fallacy of insufficient sample, fallacy of the lonely fact, hasty induction, secundum quid, converse accident, jumping to conclusions) fallacy, Inductive fallacy, Misleading vividness fallacy, Overwhelming exception fallacy, Thought-terminating cliché, Cum hoc ergo propter hoc (correlation implies causation; faculty cause/effect, coincidental correlation, correlation without causation) fallacy, Post Hoc (after this, therefore because of this) fallacy, Wrong direction (reverse causation) fallacy, Fallacy of the single cause (causal oversimplification), Furtive fallacy, Gambler's fallacy, Magical thinking fallacy, Regression fallacy, Appeal to the stone (argumentum ad lapidem) fallacy, Argument for ignorance (appeal to ignorance, argumentum ad ignorantiam) fallacy, Argument from incredulity (appeal to common sense) fallacy, Argument from repetition (argumentum ad nauseam, argumentum ad infinitum) fallacy, Argument from science (argumentum ex silentio) fallacy, Ignoratio elenchi (irrelevent conclusion, missing the point) fallacy, Red herring fallacy, Ad hominem fallacy, Circumstantial ad hominem fallacy, Poisoning the well fallacy, Appeal to motive fallacy, Kafka-trapping fallacy, Tone policing fallacy, Traitorous critic fallacy (ergo decedo, ‘ thus leave’), Appeal to authority (argument from authority, argumentum ad verecundiam) fallacy, Appeal to accomplishment fallacy, Courtier's reply fallacy, Appeal to consequences (argumentum ad consequentiam) fallacy, Appeal to emotion fallacy, Appeal to fear fallacy, Appeal to flattery fallacy, Appeal to pity (argumentum ad misericordiam) fallacy, Appeal to ridicule fallacy, Appeal to spite fallacy, judgmental language fallacy, Pooh-Pooh/strawman fallacy, wishful thinking fallacy, judgmental language fallacy, Pooh-Pooh fallacy, wishful thinking fallacy, Appeal to nature fallacy, Appeal to novelty (argumentum novitatis, argumentum ad antiquitatis) fallacy, Appeal to poverty (argumentum ad Lazarum) fallacy, Appeal to tradition (argumentum ad antiquitatem) fallacy, Appeal to wealth (argumentum ad crumenam) fallacy, Argumentum ad baculum (appeal to the stick, appeal to force, appeal to threat) fallacy, Argumentum ad populum (appeal to widespread belief, bandwagon argument, appeal to the majority, appeal to the people) fallacy, Association fallacy (guilt by association and honor by association) fallacy, Ipse dixit (bare assertion fallacy), Bulverism (psychogenetic fallacy) fallacy, Chronological snobbery fallacy, Fallacy of relative privation (appeal to worse problems, or not as bad as), Genetic fallacy, “I'm entitled to my opinion” fallacy, Moralistic fallacy, Naturalistic fallacy, Is-ought fallacy, Moralistic fallacy (anti-naturalistic fallacy), Texas sharpshooter fallacy, Tu quoque (‘you too’—appeal to hypocrisy, whataboutism) fallacy, two wrongs make a right fallacy, Denial of responsibility fallacy, Denial of injury fallacy, Social Weighting fallacy, Denial of Victim fallacy, Appeal to higher loyalties fallacy, Metaphor of the Ledger fallacy, Vacuous truth fallacy, Appeal to Irrelevant Authority fallacy, Not a cause for a cause fallacy, Composition fallacy, Division fallacy, future-oriented thinking fallacy, operant conditioning, hedonic motivation, free will, Interpersonal Harm Aversion, Bio-genetics, Predispositions, Endocrinology, Testosterone, Amygdala, Hypermutations, Impulsiveness, Self-concept, Genetics-Genotype variants of the 5-HTTLPR polymorphism, Intelligence, cognitive flexibility, tacit knowledge, Law of Triviality, Law of the Instrument/Maslow's Hammer, Attentional Bias, Functional fixedness, Noise, Personal Integrity (variations therein), locus of control, rosy retrospection, Present Bias, Over justification Effect and Motivation, Choice-supportive bias, analysis paralysis, Overchoice, conceptual skill (variations therein), The illusory truth effect (also known as the illusion of truth effect, validity effect, truth effect, or the reiteration effect), Elaboration Likelihood Model, Resilience (variations therein), Einstellung effect, Circle of Concern, Circle of Influence, avoidance motivation, Monotasking, Hofstadter's Law, Escalation of Commitment, optimistic/pessimistic cognitive style, Omission Bias, cognitive estrangement, high/low self-monitoring, Relevance Insensitivity, Habits-Involuntary (Piacularity), Egocentricity, Cognitive Development (including stages such as adolescence), Machiavellianism, Lack of Moral Courage, Motivated Reasoning, Moral Disengagement, Intuition, Monotasking, Dual-processing in human cognition, Biology, Neuro-anatomy, Cryptomorality/Preference falsification, Deception—Self, Deception—Others, Stress, Cascade Effect, Mega-politics, Isolation, Ill-Conceived Goals, Overvalued Outcomes, Attention Control, Frame of Reference Problem, Socio-Economic Status, Choice Architecture, Stigma, Bureaucracy, Moral Education, Environmental Factors, Ethical Incommensurability, Algorithms, Hararian Hacking of Humans via Algorithms, Planning Horizon, Situation, Banalization, Professional cultures, Organizational Culture, organizational norms, cultural meanings, cultural change, and many more, including those discovered by a proprietary impediment-searching tool. The present invention may help reduce the thousands of risks (of which the impediments listed above are only a fraction) known to imperil decisions.

The semiotic data of the present invention comprises a set of interconnected systems, tools, techniques, standardizations, and algorithms that together create a suite of capacities as well as the AI, infrastructure and related processes necessary for their continued function. Semiotic Machines refer to AI that do the work of semioticians, linguists, speech language pathologists and more, needed for the algorithmic agents and humanoid robots that connect to the standardized, universal semiotic layer. These devices that supply the database with the content, knowledge, know how, processes from theories, concepts, and the like, as well as new content and contextual knowledge and new terms and new expressions and new theories and new concepts and more. The semiotic database implements metasemiotic linking, which goes beyond the layer of semantics and semiotics into sign systems that go beyond primarily human uses into areas such as the signing systems of animals and plants. Metasemiotic linking refers to the finding, analysis, and most importantly, engineering semiotic links between and among all semiotic systems and signs, and not just humanistic or linguistic sign systems. It is via token that links terms together. Complex processes such as the hermeneutic probability scoring and emotional resonance scoring may implement semiotic tokens.

The present invention implements a plurality of data transformers for deriving terms from various data sources in order to identify meanings and links, as well as adding new ones. The data transformers may comprise visual-optics transformers, language-speech-communication transformers, emotion-related transformers, action-behavior transformers, and language-performance transformers. In all cases, the transformers are configured to convert data collected from sensors or intermediary data modules into term/tone/weight/context data interpretable by the semiotic database. Each data transformer may implement a corresponding database of mapping information and a corresponding AI model configured to estimate final data from the input data.

### EMBODIMENTS

The following are non-limiting embodiments of the present invention:

Embodiment 1: A computer system (100) for aiding in decision-making in a situation involving one or more users, the system (100) comprising: one or more input devices (110), each input device configured to accept one or more inputs from the one or more users, each input of the one or more inputs comprising measurements of one or more physiological parameters, measurements of one or more environmental parameters, one or more user inputs, or a combination thereof; a cloud server (120) comprising: a behavior-based user profile associated with a decision-making user of the one or more users; a decision Artificial Intelligence (AI) model (125) associated with the behavior-based user profile, trained by existing decision-making data comprising relationships between properties and quality of decision-making, configured to accept the one or more inputs from the one or more input devices (110) and a description of the situation, identify one or more decision-making impediments in the one or more inputs, the description of the situation, or a combination thereof, and generate one or more decision-enhancing suggestions as output; wherein the decision AI model (125) is further trained by past decisions made by the decision-making user and decision-enhancing suggestions thereof, such that the decision AI model (125) provides personalized aid to the decision-making user; a database AI model (126) communicatively coupled to the decision AI model (125), trained by a database of known impediments to optimal decision making and thinking, configured to accept the one or more decision-making impediments from the decision AI model (125) and generate one or more solutions to the one or more decision-making impediments at output, wherein the one or more decision-enhancing suggestions comprise the one or more solutions; computer-readable instructions for: accepting the one or more inputs from the one or more input devices (110) and the description of the situation; inputting the one or more inputs from the one or more input devices (110) and the description of the situation into the decision AI model (125); and returning the one or more decision-enhancing suggestions from the decision AI model (125); a processor (130) communicatively coupled to the cloud server (120) and the one or more input devices (110), configured to execute computer-readable instructions; and a memory component (140) operatively coupled to the processor (130), comprising computer-readable instructions for: receiving the description of the situation from the one or more users; receiving the one or more inputs from the one or more input devices (110); transmitting the one or more inputs and the description of the situation to the cloud server (120); and receiving the one or more decision-enhancing suggestions.

Embodiment 2: The system (100) of Embodiment 1, wherein the one or more input devices (110) comprise one or more cameras, one or more microphones, one or more physiological sensors, one or more user interface devices, or a combination thereof.

Embodiment 3: The system (100) of Embodiment 2, wherein the one or more inputs comprise facial expression measurements.

Embodiment 4: The system (100) of Embodiment 3, wherein the cloud server (120) further comprises a Convolutional Neural Network (CNN) configured to accept the facial expression measurements as input and generate a quantified mental state as output, wherein the quantified mental state is inputted into the decision AI model (125).

Embodiment 5: The system (100) of Embodiment 2, wherein the one or more inputs comprise speech analysis data.

Embodiment 6: The system (100) of Embodiment 5, wherein the cloud server (120) further comprises a Long Short-Term Memory Network (LSTM) configured to accept the speech analysis data as input and generate a quantified mental state as output, wherein the quantified mental state is inputted into the decision AI model (125).

Embodiment 7: The system (100) of Embodiment 2, wherein the one or more inputs comprise heart rate, cortisol levels, or a combination thereof.

Embodiment 8: The system (100) of Embodiment 1, wherein the cloud server (120) further comprises a Recurrent Neural Network (RNN) configured to accept text data from one or more sources as input and generate the decision-making data as output.

Embodiment 9: The system (100) of Embodiment 1, wherein the cloud server (120) further comprises a Generative Adversarial Network (GAN) configured to accept descriptions of situations as input and generate the decision-making data as output.

Embodiment 10: The system (100) of Embodiment 1, wherein the cloud server (120) further comprises a Natural Language Processing (NLP) model configured to accept a text input from the one or more users as input and return a text response to the text input as output, wherein the NLP model is trained by the decision-making data such that the text responses comprise queries about a mental state of the one or more users.

Embodiment 11: The system (100) of Embodiment 10, wherein the one or more user inputs comprise one or more text inputs, verbal inputs, non-verbal inputs, or a combination thereof, and one or more text responses from an interaction between the one or more users and the NLP model.

Embodiment 12: The system (100) of Embodiment 10, wherein the NLP model is further configured to accept the text input from the one or more users as input, identify one or more decision-making impairments in the text input, and notify the one or more users of the one or more decision-making impairments.

Embodiment 13: The system (100) of Embodiment 1, wherein the one or more user inputs comprise one or more user proposed actions, wherein the one or more decision-enhancing suggestions comprise one or more AI proposed actions, wherein the decision AI model (125) is further configured to generate a plurality of additional outputs based on the one or more solutions from the database AI model (126), the one or more additional outputs comprising a decision quality assessment, sets of data and information supporting the recommended decision, a list of potential implications of the one or more user proposed actions, and a list of potential implications of the one or more AI proposed actions.

Embodiment 14: A computer-implemented method for aiding in decision-making in a situation involving one or more users, the method comprising: measuring, by one or more input devices (110), one or more inputs of the one or more users, each input of the one or more inputs comprising measurements of one or more physiological parameters, measurements of one or more environmental parameters, one or more user inputs, or a combination thereof; receiving a description of the situation from the one or more users; inputting the one or more inputs and the description of the situation into a decision Artificial Intelligence (AI) model (125) trained by existing decision-making data comprising relationships between properties and quality of decision-making, configured to accept the one or more inputs from the one or more input devices (110) and a description of the situation, identify one or more decision-making impediments in the one or more inputs, the description of the situation, or a combination thereof, and generate one or more decision-enhancing suggestions as output; wherein the decision AI model (125) is further trained by past decisions made by the decision-making user and decision-enhancing suggestions thereof, such that the decision AI model (125) provides personalized aid to the decision-making user; wherein the one or more decision-enhancing suggestions comprise one or more solutions generated by a database AI model (126) communicatively coupled to the decision AI model (125), trained by a database of known impediments to optimal decision making and thinking, configured to accept the one or more decision-making impediments from the decision AI model (125) and generate the one or more solutions to the one or more decision-making impediments at output; and returning the one or more decision-enhancing suggestions from the decision AI model (125).

Embodiment 15: The method of Embodiment 14, wherein the one or more input devices (110) comprise one or more cameras, one or more microphones, one or more physiological sensors, or a combination thereof.

Embodiment 16: The method of Embodiment 15, wherein the one or more inputs comprise facial expression measurements.

Embodiment 17: The method of Embodiment 16 further comprising inputting the facial expression measurements into a Convolutional Neural Network (CNN) configured to accept the facial expression measurements as input and generate a quantified mental state as output, wherein the quantified mental state is inputted into the decision AI model (125).

Embodiment 18: The method of Embodiment 15, wherein the one or more inputs comprise speech analysis data.

Embodiment 19: The method of Embodiment 18 further comprising inputting the speech analysis data into a Long Short-Term Memory Network (LSTM) configured to accept the speech analysis data as input and generate a quantified mental state as output, wherein the quantified mental state is inputted into the decision AI model (125).

Embodiment 20: The method of Embodiment 15, wherein the one or more inputs comprise heart rate, cortisol levels, or a combination thereof.

Embodiment 21: The method of Embodiment 14 further comprising inputting text data from one or more sources into a Recurrent Neural Network (RNN) configured to accept the text data as input and generate the decision-making data as output.

Embodiment 22: The method of Embodiment 14 further comprising inputting descriptions of situations into a Generative Adversarial Network (GAN) configured to accept the descriptions of situations as input and generate the decision-making data as output.

Embodiment 23: The method of Embodiment 14, wherein the one or more user inputs comprise one or more text inputs, verbal inputs, non-verbal inputs, or a combination thereof, and one or more text responses from an interaction between the one or more users and a Natural Language Processing (NLP) model configured to accept a text input from the one or more users as input and return a text response to the text input as output, wherein the NLP model is trained by the decision-making data such that the text responses comprise queries about a mental state of the one or more users.

Embodiment 24: The method of Embodiment 23 further comprising identifying, by the NLP model, one or more decision-making impairments in the text input, and notifying, by the NLP model, the one or more users of the one or more decision-making impairments.

Embodiment 25: The method of Embodiment 24, wherein the one or more user inputs comprise one or more user proposed actions, wherein the one or more decision-enhancing suggestions comprise one or more AI proposed actions, wherein the decision AI model (125) is further configured to generate a plurality of additional outputs based on the one or more solutions from the database AI model (126), the one or more additional outputs comprising a decision quality assessment, sets of data and information supporting the recommended decision, a list of potential implications of the one or more user proposed actions, and a list of potential implications of the one or more AI proposed actions.

Embodiment 26: A non-transitory computer medium (140) comprising computer-readable instructions that, when executed by a processor (130), cause the processor (130) to: receive one or more inputs of the one or more users from one or more input devices (110) communicatively coupled to the processor (130), each input of the one or more inputs comprising measurements of one or more physiological parameters, measurements of one or more environmental parameters, one or more user inputs, or a combination thereof; receive a description of the situation from the one or more users; input the one or more inputs and the description of the situation into a decision Artificial Intelligence (AI) model (125) trained by existing decision-making data comprising relationships between properties and quality of decision-making, configured to accept the one or more inputs from the one or more input devices (110) and a description of the situation, identify one or more decision-making impediments in the one or more inputs, the description of the situation, or a combination thereof, and generate one or more decision-enhancing suggestions as output; wherein the decision AI model (125) is further trained by past decisions made by the decision-making user and decision-enhancing suggestions thereof, such that the decision AI model (125) provides personalized aid to the decision-making user; wherein the one or more decision-enhancing suggestions comprise one or more solutions generated by a database AI model (126) communicatively coupled to the decision AI model (125), trained by a database of known impediments to optimal decision making and thinking, configured to accept the one or more decision-making impediments from the decision AI model (125) and generate the one or more solutions to the one or more decision-making impediments at output; and return the one or more decision-enhancing suggestions from the decision AI model (125).

Embodiment 27: The non-transitory computer medium (140) of Embodiment 26, wherein the one or more input devices (110) comprise one or more cameras, one or more microphones, one or more physiological sensors, or a combination thereof.

Embodiment 28: The non-transitory computer medium (140) of Embodiment 27, wherein the one or more inputs comprise facial expression measurements.

Embodiment 29: The non-transitory computer medium (140) of Embodiment 28 further causing the processor (130) to input the facial expression measurements into a Convolutional Neural Network (CNN) configured to accept the facial expression measurements as input and generate a quantified mental state as output, wherein the quantified mental state is inputted into the decision AI model (125).

Embodiment 30: The non-transitory computer medium (140) of Embodiment 27, wherein the one or more inputs comprise speech analysis data.

Embodiment 31: The non-transitory computer medium (140) of Embodiment 30 further causing the processor (130) to input the speech analysis data into a Long Short-Term Memory Network (LSTM) configured to accept the speech analysis data as input and generate a quantified mental state as output, wherein the quantified mental state is inputted into the decision AI model (125).

Embodiment 32: The non-transitory computer medium (140) of Embodiment 27, wherein the one or more inputs comprise heart rate, cortisol levels, or a combination thereof.

Embodiment 33: The non-transitory computer medium (140) of Embodiment 26 further causing the processor (130) to input text data from one or more sources into a Recurrent Neural Network (RNN) configured to accept the text data as input and generate the decision-making data as output.

Embodiment 34: The non-transitory computer medium (140) of Embodiment 26 further causing the processor (130) to input descriptions of situations into a Generative Adversarial Network (GAN) configured to accept the descriptions of situations as input and generate the decision-making data as output.

Embodiment 35: The non-transitory computer medium (140) of Embodiment 26, wherein the one or more user inputs comprise one or more text inputs, verbal inputs, non-verbal inputs, or a combination thereof, and one or more text responses from an interaction between the one or more users and a Natural Language Processing (NLP) model configured to accept a text input from the one or more users as input and return a text response to the text input as output, wherein the NLP model is trained by the decision-making data such that the text responses comprise queries about a mental state of the one or more users.

Embodiment 36: The non-transitory computer medium (140) of Embodiment 35 further causing the processor (130) to identify, by the NLP model, one or more decision-making impairments in the text input, and notify, by the NLP model, the one or more users of the one or more decision-making impairments.

Embodiment 37: The non-transitory computer medium (140) of Embodiment 26, wherein the one or more user inputs comprise one or more user proposed actions, wherein the one or more decision-enhancing suggestions comprise one or more AI proposed actions, wherein the decision AI model (125) is further configured to generate a plurality of additional outputs based on the one or more solutions from the database AI model (126), the one or more additional outputs comprising a decision quality assessment, sets of data and information supporting the recommended decision, a list of potential implications of the one or more user proposed actions, and a list of potential implications of the one or more AI proposed actions.

Embodiment 38: A computer system (100) for aiding in decision-making in a situation involving one or more users, the system (100) comprising: one or more input devices (110), each input device configured to accept one or more inputs from the one or more users, each input of the one or more inputs comprising measurements of one or more physiological parameters, measurements of one or more environmental parameters, one or more user inputs comprising one or more user proposed actions, or a combination thereof; a cloud server (120) comprising: a behavior-based user profile associated with a decision-making user of the one or more users; a decision Artificial Intelligence (AI) model (125) associated with the behavior-based user profile, trained by existing decision-making data comprising relationships between properties and quality of decision-making, configured to accept the one or more inputs from the one or more input devices (110) and a description of the situation, identify one or more decision-making impediments in the one or more inputs, the description of the situation, or a combination thereof, and generate one or more decision-enhancing suggestions comprising one or more AI proposed actions, a decision quality assessment, sets of data and information supporting the recommended decision, a list of potential implications of the one or more user proposed actions, and a list of potential implications of the one or more AI proposed actions as output; wherein the decision AI model (125) is further trained by past decisions made by the decision-making user and outputs thereof, such that the decision AI model (125) provides personalized aid to the decision-making user; a database AI model (126) communicatively coupled to the decision AI model (125), trained by a database of known impediments to optimal decision making and thinking, configured to accept the one or more decision-making impediments from the decision AI model (125) and generate one or more solutions to the one or more decision-making impediments at output, wherein the output of the decision AI model (125) comprise the one or more solutions; computer-readable instructions for: accepting the one or more inputs from the one or more input devices (110) and the description of the situation; inputting the one or more inputs from the one or more input devices (110) and the description of the situation into the decision AI model (125); and returning the one or more decision-enhancing suggestions from the decision AI model (125); a processor (130) communicatively coupled to the cloud server (120) and the one or more input devices (110), configured to execute computer-readable instructions; and a memory component (140) operatively coupled to the processor (130), comprising computer-readable instructions for: receiving the description of the situation from the one or more users; receiving the one or more inputs from the one or more input devices (110); transmitting the one or more inputs and the description of the situation to the cloud server (120); and receiving the one or more decision-enhancing suggestions.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

Reference numbers recited herein, in the drawings, and in the claims are solely for ease of examination of this patent application and are exemplary. The reference numbers are not intended in any way to limit the scope of the claims to the particular features having the corresponding reference numbers in the drawings.

What is claimed is:

1) A computer system (100) for aiding in decision-making in a situation involving one or more users, the system (100) comprising:
a) a plurality of input devices comprising one or more cameras, one or more microphones, one or more physiological sensors, and one or more text-input interface devices, each input device configured to accept a plurality of inputs from the one or more users, each input of the plurality of inputs comprising measurements of one or more physiological parameters, measurements of one or more environmental parameters, and one or more user inputs comprising one or more user-proposed actions;
b) a cloud server (120) communicatively coupled to the plurality of input devices comprising:
i) a behavior-based user profile associated with a decision-making user of the one or more users;
ii) a semiotic database (123) comprising a plurality of terms, each term comprising one or more weighted emotional meanings, each weighted emotional meaning comprising a meaning of the term corresponding to a context and a tone, and a weight value corresponding to an emotional weight of the term given the context and the tone, and one or more relationships between the term and other terms of the semiotic database (123) based on the context and the tone;
iii) a data pre-processing module (124) comprising computer-readable instructions for:
A) receiving the plurality of inputs from the one or more users;
B) identifying a plurality of terms in the one or more user inputs;
C) deriving one or more physiological descriptive terms corresponding to the measurements of the one or more physiological parameters and one or more environmental descriptive terms corresponding to the measurements of the one or more environmental parameters, wherein the one or more physiological descriptive terms and the one or more environmental descriptive terms are incorporated into the plurality of terms;
D) estimating, based on the plurality of terms and the semiotic database (123), an estimated context based on corresponding contexts according to relationships between the plurality of terms as the plurality of terms appear in the semiotic database (123); and
E) estimating, based on the plurality of inputs and the semiotic database (123), an estimated tone of each user based on corresponding tones according to relationships between the plurality of terms as the plurality of terms appear in the semiotic database (123) and the estimated context;
iv) a decision Artificial Intelligence (AI) model (125) associated with the behavior-based user profile, trained by existing decision-making data comprising relationships between contexts and tones and quality of decision-making, configured to accept the plurality of inputs, the estimated context, and the estimated tone, identify one or more decision-making impediments in the plurality of inputs;
wherein the decision AI model (125) is further trained by past decisions made by the decision-making user and outputs thereof, such that the decision AI model (125) provides personalized aid to the decision-making user;
v) a database AI model (126) communicatively coupled to the decision AI model (125), trained by a database of known impediments to optimal decision making and thinking, configured to accept the one or more decision-making impediments from the decision AI model (125) and generate one or more decision-enhancing suggestions comprising one or more AI proposed actions, a decision quality assessment, sets of data and information supporting a recommended decision, a list of potential implications of the one or more user proposed actions, and a list of potential implications of the one or more AI proposed actions as output; and
vi) computer-readable instructions for:
A) accepting the plurality of inputs from the plurality of input devices;
B) inputting the plurality of inputs from the plurality of input devices into the data pre-processing module (124);
C) inputting the plurality of inputs, the estimated context, and the estimated tone into the decision AI model (125); and
D) inputting the one or more decision-making impediments into the database AI model (126);
b) a processor (130) communicatively coupled to the cloud server (120) and the plurality of input devices, configured to execute computer-readable instructions; and
c) a memory component operatively coupled to the processor (130), comprising computer-readable instructions for:
i) receiving the plurality of inputs from the plurality of input devices;
ii) transmitting the plurality of inputs to the cloud server (120);
iii) receiving the one or more decision-enhancing suggestions; and
iv) displaying the one or more decision-enhancing suggestions to the one or more users.

2) A computer-implemented method for aiding in decision-making in a situation involving one or more users, the method comprising:
a) measuring, by a plurality of input devices (110), a plurality of inputs of the one or more users, each input of the plurality of inputs comprising measurements of one or more physiological parameters, measurements of one or more environmental parameters, and one or more user inputs comprising one or more user-proposed actions;
b) inputting the plurality of inputs into a decision Artificial Intelligence (AI) model (125) trained by existing decision-making data comprising relationships between properties and quality of decision-making, configured to accept the plurality of inputs from the plurality of input devices (110) and identify one or more decision-making impediments in the plurality of inputs;
wherein the decision AI model (125) is further trained by past decisions made by the decision-making user and decision-enhancing suggestions thereof, such that the decision AI model (125) provides personalized aid to a decision-making user of the one or more users;
c) inputting the one or more decision-making impediments into a database AI model (126) communicatively coupled to the decision AI model (125), trained by a database of known impediments to optimal decision making and thinking, configured to accept the one or more decision-making impediments from the decision AI model (125) and generate one or more decision-enhancing suggestions as output; and
d) returning the one or more decision-enhancing suggestions from the database AI model (126).

3) The method of claim 2, wherein the plurality of input devices (110) comprise one or more cameras, one or more microphones, one or more physiological sensors, or a combination thereof.

4) The method of claim 3, wherein the plurality of inputs comprise facial expression measurements.

5) The method of claim 4 further comprising inputting the facial expression measurements into a Convolutional Neural Network (CNN) configured to accept the facial expression measurements as input and generate a quantified mental state as output, wherein the quantified mental state is inputted into the decision AI model (125).

6) The method of claim 3, wherein the plurality of inputs comprise speech analysis data, wherein the method further comprises inputting the speech analysis data into a Long Short-Term Memory Network (LSTM) configured to accept the speech analysis data as input and generate a quantified mental state as output, wherein the quantified mental state is inputted into the decision AI model (125).

7) The method of claim 3, wherein the plurality of inputs comprise heart rate, cortisol levels, or a combination thereof.

8) The method of claim 2 further comprising inputting descriptions of situations into a Generative Adversarial Network (GAN) configured to accept the descriptions of situations as input and generate the decision-making data as output.

9) The method of claim 2, wherein the one or more user inputs comprise one or more text inputs, verbal inputs, non-verbal inputs, or a combination thereof, and one or more text responses from an interaction between the one or more users and a Natural Language Processing (NLP) model configured to accept a text input from the one or more users as input and return a text response to the text input as output, wherein the NLP model is trained by the decision-making data such that the one or more text responses comprise queries about a mental state of the one or more users.

10) The method of claim 9 further comprising identifying, by the NLP model, one or more decision-making impairments in the text input, and notifying, by the NLP model, the one or more users of the one or more decision-making impairments.

11) A non-transitory computer medium (140) comprising computer-readable instructions that, when executed by a processor (130), cause the processor (130) to:
a) receive a plurality of inputs corresponding to one or more users from a plurality of input devices (110) communicatively coupled to the processor (130), each input of the plurality of inputs comprising measurements of one or more physiological parameters, measurements of one or more environmental parameters, and one or more user inputs comprising one or more user-proposed actions;
b) input the plurality of inputs into a decision Artificial Intelligence (AI) model (125) trained by existing decision-making data comprising relationships between properties and quality of decision-making, configured to accept the plurality of inputs from the plurality of input devices (110) and identify one or more decision-making impediments in the plurality of inputs;
wherein the decision AI model (125) is further trained by past decisions made by the decision-making user and decision-enhancing suggestions thereof, such that the decision AI model (125) provides personalized aid to the decision-making user;
c) input the one or more decision-making impediments into a database AI model (126) communicatively coupled to the decision AI model (125), trained by a database of known impediments to optimal decision making and thinking, configured to accept the one or more decision-making impediments from the decision AI model (125) and generate one or more decision-enhancing suggestions as output; and
d) return the one or more decision-enhancing suggestions from the database AI model (126).

12) The non-transitory computer medium (140) of claim 11, wherein the plurality of input devices (110) comprise one or more cameras, one or more microphones, one or more physiological sensors, or a combination thereof.

13) The non-transitory computer medium (140) of claim 12, wherein the plurality of inputs comprise facial expression measurements.

14) The non-transitory computer medium (140) of claim 13 further causing the processor (130) to input the facial expression measurements into a Convolutional Neural Network (CNN) configured to accept the facial expression measurements as input and generate a quantified mental state as output, wherein the quantified mental state is inputted into the decision AI model (125).

15) The non-transitory computer medium (140) of claim 12, wherein the plurality of inputs comprise speech analysis data.

16) The non-transitory computer medium (140) of claim 15 further causing the processor (130) to input the speech analysis data into a Long Short-Term Memory Network (LSTM) configured to accept the speech analysis data as input and generate a quantified mental state as output, wherein the quantified mental state is inputted into the decision AI model (125).

17) The non-transitory computer medium (140) of claim 13, wherein the plurality of inputs comprise heart rate, cortisol levels, or a combination thereof.

18) The non-transitory computer medium (140) of claim 12 further causing the processor (130) to input descriptions of situations into a Generative Adversarial Network (GAN) configured to accept the descriptions of situations as input and generate the decision-making data as output.

19) The non-transitory computer medium (140) of claim 12, wherein the one or more user inputs comprise one or more text inputs, verbal inputs, non-verbal inputs, or a combination thereof, and one or more text responses from an interaction between the one or more users and a Natural Language Processing (NLP) model configured to accept a text input from the one or more users as input and return a text response to the text input as output, wherein the NLP model is trained by the decision-making data such that the one or more text responses comprise queries about a mental state of the one or more users.

20) The non-transitory computer medium (140) of claim 19 further causing the processor (130) to identify, by the NLP model, one or more decision-making impairments in the text input, and notify, by the NLP model, the one or more users of the one or more decision-making impairments.
